(19) United States
(12) Patent Application Publication
(10) Pub. No.: US 2020/0209725 A1
(43) Pub. Date: Jul. 2, 2020

(54) PROJECTION SYSTEM AND PROJECTION METHOD

(71) Applicant: Coretronic Corporation, Hsin-Chu (TW)

(72) Inventors: Je-Fu Cheng, Hsin-Chu (TW); Lei-Chih Chang, Hsin-Chu (TW)

(73) Assignee: Coretronic Corporation, Hsin-Chu (TW)

(21) Appl. No.: 16/714,802

(22) Filed: Dec. 16, 2019

(30) Foreign Application Priority Data
Dec. 28, 2018 (CN) 201811621904.0

(51) Int. Cl. G03B 21/20; G03B 17/54; H04N 9/31

(52) U.S. Cl. CPC G03B 21/2053; G03B 21/2033; H04N 9/3173; G03B 17/54

(57) ABSTRACT

The disclosure provides a projection system and a projection method using the projection system. The projection system can project a projection beam toward the projection target. The projection system includes an image capturing device and a projection device. The image capturing device can capture an appearance image containing the path target as image information. The projection device is electrically connected to the image capturing device. The projection device can provide a projection beam, and the projection beam includes a first beam and a second beam. The path target is located on the transmitting path of the first beam, and the second beam is projected to the projection target. The projection device can adjust the luminous intensity of the first beam according to the image information, so as to reduce the luminous intensity of the first beam.

### CROSS-REFERENCE TO RELATED APPLICATION

This application claims the priority benefit of China application serial no. 201811621904.0, filed on Dec. 28, 2018. The entirety of the above-mentioned patent application is hereby incorporated by reference herein and made a part of this specification.

### BACKGROUND OF THE DISCLOSURE

### Field of the Disclosure

The disclosure relates to an optical system and an optical system operating method, and more particularly to a projection system and a projection method.

### Description of Related Art

The projection device is a display device for generating a projection image, and has been continuously improved with the evolution and innovation of technology. The imaging principle of the projection device is to convert the illumination beam generated by the illumination system into an image beam by a light valve, and then the image beam is projected onto a projection target (for example, a screen or a wall surface) through the projection lens to form a projection image.

However, in conditions where a projection device is used, a narrator may stand on the path of the projection beam, and the narrator may enter the projection range of the projection device. Therefore, the beam emitted from the projection device may be irradiated on the narrator's body, face or even eyes, which may distracts the narrator or causes harm to the body. At the same time, it may also make a viewer uncomfortable. Therefore, it is important to prevent a narrator from being distracted or harmed by the image beam.

The disclosed in this BACKGROUND section is only for enhancement of understanding of the BACKGROUND section of the described technology and therefore it may contain information that does not form the prior art that is already known to a person of ordinary skill in the art. Further, the information disclosed in the BACKGROUND section does not mean that one or more problems to be resolved by one or more embodiments of the disclosure were acknowledged by a person of ordinary skill in the art.

### SUMMARY OF THE DISCLOSURE

The disclosure provides a projection system and a projection method, which is capable of preventing a light beam from being directly irradiated onto a person, a human face, a human eye or other targets.

The objectives and advantages of the disclosure may be further understood in the technical features disclosed in the disclosure.

To achieve one or a part or all the objectives or other objectives, an embodiment of the disclosure provides a projection system that projects a projection beam toward a projection target. The projection system includes an image capturing device and a projection device. The image capturing device may capture an appearance image containing a path target as image information. The projection device is electrically connected to the image capturing device. The projection device may provide a projection beam, and the projection beam includes a first beam and a second beam, the path target is located on the transmitting path of the first beam, and the second beam is projected onto the projection target. The projection device may adjust the luminous intensity of the first beam according to the image information, so as to reduce the luminous intensity of the first beam.

To achieve one or a part or all the objectives or other objectives, an embodiment of the disclosure provides a projection method. The projection method includes providing a projection beam to a projection target. The projection beam includes a first beam and a second beam. The projection method includes capturing an appearance image containing a path target as image information, and the path target is located on a transmitting path of the first beam. The projection method further includes adjusting the luminous intensity of the first beam according to the image information, so as to reduce the luminous intensity of the first beam.

Based on the above, the embodiments of the disclosure may have at least one of the following advantages or effects. In the projection system and the projection method of the embodiment, the image information is captured by the image capturing device, and the image information may be an appearance image including path targets such as a person, a human face, a human eye and so on. The projection system adjusts the luminous intensity of at least a portion of the projected light beam according to the image information, and reduces the luminous intensity of the light beam directed to the path target. In this configuration, by adjusting the luminous intensity of the portion of the light beam to be projected onto the projection target, it is possible to prevent the light beam from being directly irradiated onto a person, a human face, a human eye or other path targets, so that the user is not distracted or harmed by the projection beam when entering the projection region.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a projection system according to an embodiment of the disclosure.

FIG. 2 is a schematic view of a projection system according to another embodiment of the disclosure.

FIG. 3 is a schematic view of the projection system of the embodiment of FIG. 2 during calibration.

FIG. 4 is a flow chart of steps of a projection method according to an embodiment of the disclosure.

### DESCRIPTION OF EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

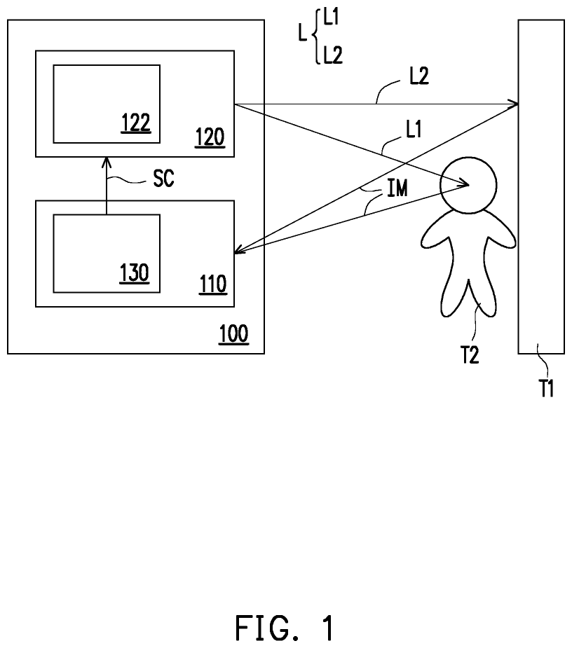

FIG. 1 is a schematic view of a projection system according to an embodiment of the disclosure. Please refer to FIG. 1, the embodiment provides a projection system 100 that is capable of projecting a projection beam L toward a projection target T1 and capable of adjusting the projection beam L according to an appearance image. Specifically, in the embodiment, the projection system 100 includes the image capturing device 110 and the projection device 120, and the image capturing device 110 and the projection device 120 are electrically connected to each other. The projection device 120 may project a projection beam L toward the projection target T1. The projection device 120 is, for example, a laser projector, and the projection target T1 is, for example, a screen or a wall surface. However, the disclosure is not limited thereto. The projection beam L includes a first beam L1 and a second beam L2. When a path target T2 enters into the transmitting path of the projection beam L, the part of the projection beam L transmitted toward the path target T2 is defined as the first beam L1, and another part of the projection beam L transmitted to the projection target T1 is defined as the second beam L2. The second beam L2 does not pass the path target T2. In this embodiment, the path target T2 may be a person, a human face, a human eye, or other specific objects that are not suitable for being irradiated with a light beam. However, the disclosure is not limited thereto.

The image capturing device 110 may capture an appearance image including the path target T2 as the image information IM. In an embodiment, the image capturing device 110 may capture a common appearance image of the projection target T1 and the path target T2 as the image information IM. In other embodiments, the image capturing device 110 may also only capture the appearance image of the path target T2. The following description takes a common appearance image of the projection target T1 and the path target T2 as an example, but the disclosure is not limited thereto. The image capturing device 110 is, for example, a camera or a video camera. However, the disclosure is not limited thereto. In some embodiments, the image capturing device 110 may be disposed in the projection device 120. For example, the image capturing device 110 may be a built-in image capturing module of the projection device 120. In other embodiments, the image capturing device 110 may also be disposed outside the projection device 120, and can be electrically connected to the projection device 120 by wireless communication or the like. The image information IM is, for example, an image picture or a video captured by the image capturing device 110, but the disclosure is not limited thereto. The following description takes an image picture as an example. When the projection system 100 performs projection, the image capturing device 110 performs image capturing on the appearance image of the projection target T1 and the path target T2 to generate the image information IM.

After the image capturing device 110 captures the appearance image of the projection target T1 and the path target T2 to generate the image information IM, the projection device 120 adjusts the luminous intensity of the first beam L1 according to the image information IM, so as to reduce the luminous intensity of the first beam L1. In other words, the luminous intensity of the first beam L1 directed to the projection target T1 may be changed according to the image information IM.

Specifically, the projection system 100 further includes a processing unit 130, and the projection device 120 includes a light valve 122. For example, the processing unit 130 includes, for example, a central processing unit (CPU), a microprocessor, a digital signal processor (DSP), a programmable controller, a programmable logic device (PLD) or other similar devices or a combination of these devices, and the disclosure is not limited thereto. The light valve 122 includes reflective light modulators such as a liquid crystal on silicon panel (LCoS panel) and a digital micro-mirror device (DMD). In some embodiments, for example, the light valve 122 may also include transmissive light modulators such as a transparent liquid crystal panel, an electro-optical modulator, a maganeto-optic modulator and an acousto-optic modulator (AOM). However, the disclosure adds no limitation to the format and type of the light valve 122.

In an embodiment, the processing unit 130 is electrically connected to the image capturing device 110 and the projection device 120. For example, as shown in FIG. 1, the processing unit 130 may be built in the image capturing device 110. In other embodiments, the processing unit 130 may also be built in the projection device 120. In the embodiment illustrated in FIG. 1, the processing unit 130 may receive the image information IM acquired by the image capturing device 110 and process the same to provide an adjustment control signal SC to the projection device 120. The projection device 120 may receive the adjustment control signal SC to adjust the luminous intensity of the first beam L1. In the embodiment, the adjustment control signal SC includes, for example, image data and/or coordinate data related to the path target T2 and/or the projection target T1, but the disclosure is not limited thereto. In other words, the processing unit 130 may output and transmit the adjustment control signal SC to the projection device 120 based on the image information IM, and the adjustment control signal SC includes coordinate information related to the appearance image of the projection target T1 and the path target T2. The light valve 122 of the projection device 120 may control the light flux corresponding to the first beam L1 in according to the adjustment control signal SC.

For example, reducing the intensity of the first beam L1 may include replacing the pattern or image projected along the first beam L1 with a black pattern/image, or a low-brightness pattern/image, so as to darken the first beam L1. Specifically, reducing the intensity of the first beam L1 may also include imposing a black pattern/image or a low-brightness pattern/image on the pattern/image projected along the transmitting path of the first beam L1, such that the first beam L1 becomes dark. In other embodiments, reducing the intensity of the first beam L1 includes adjusting the direction or phase of the structures in the light valve 122 for providing the first beam L1, so as to reduce the luminous intensity of the first beam L1. For example, the luminous intensity of the first beam L1 may be reduced to zero. Specifically, in the embodiment in which the light valve 122 includes the DMD, the angle of the reflective mirrors corresponding to the first beam L1 in the DMD may be controlled according to the adjustment control signal SC, such that the angles of the reflective mirrors are in a state of not projecting the first beam L1, or a state of partially projecting the first beam L1. In the embodiment in which the light valve 122 includes a LCoS panel, the polarizing state of the liquid crystal structures corresponding to the first beam L1 in the LCoS panel may be controlled according to the adjustment control signal SC, such that the liquid crystal structures are in a state of not projecting the first beam L1, or a state of partially projecting the first beam L1, but the disclosure is not limited thereto.

In the projection system 100 of the embodiment, by capturing the image information through the image capturing device 110, and adjusting the luminous intensity of at least a portion of the projected light beam (for example, the first beam L1) according to the image information, the luminous intensity of the light beam (for example, first beam L1) projected to the person can be reduced. In this way, it is possible to prevent the light beam from being directly irradiated onto a person, a human face, a human eye or the path target T2, so that the user may not be irradiated or distracted by the projection beam L, or even harmed when entering the projection region.

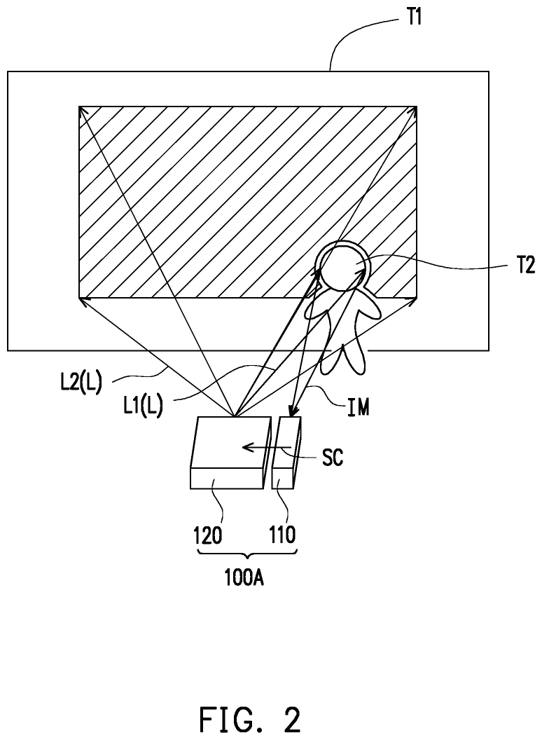

FIG. 2 is a schematic view of a projection system according to another embodiment of the disclosure. Referring to FIG. 2, a projection system 100A of the embodiment is similar to the projection system 100 of FIG. 1. The difference between the two is that in the embodiment, the processing unit (not shown) may be selectively built in the projection device 120, and the image information IM including the path target T2 obtained by the image capturing device 110 may be tracked or monitored by performing related algorithms such as artificial intelligence with respect to the route of the path target O2. The processing unit (not shown) performs calculation according to the image information IM including the obtained path target T2 to obtain the adjustment control signal SC including the coordinate data of the path target T2. The luminous intensity of the light beam (i.e., the first beam L1 illustrated in FIG. 1) to be projected along the projection path where the path target T2 is located is adjusted to zero based on the calculated adjustment control signal SC. In the embodiment, the projection beam L is selectively projected according to the adjustment control signal SC including the coordinate information of the path target T2, so as to avoid light irradiating toward the path target T2 (for example, a human body), as shown in FIG. 2. In some embodiments, the manner of capturing the path target T2 by the image capturing device 110 may include projecting structured light beams and performing image tracking by 3D image detecting technology or the like, but the disclosure is not limited thereto. In other embodiments, for example, the adjustment control signal SC calculated by the image capturing device 110 includes information about the distance between the path target T2 (e.g., a human face) and the projection device 120 (e.g., a projector), and the projection device 120 may project shielding patterns (e.g., a black pattern) with difference sizes at a specific position according to the distance information. For example, when the distance between the path target T2 (e.g., a human face) and the projection device 120 (e.g., a projector) is farther, the projection device 120 may project a shielding pattern with a smaller area at a corresponding position of the human face, and when the distance between the path target T2 (for example, a human face) and the projection device 120 (for example, a projector) is closer, the projection device 120 may project a shielding pattern having a larger area at a corresponding position of the human face. However, the disclosure is not limited thereto.

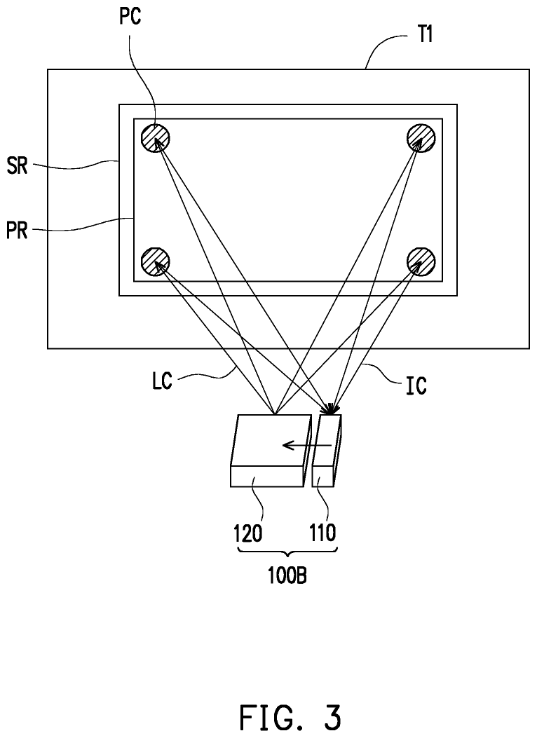

FIG. 3 is a schematic view of the projection system of the embodiment of FIG. 2 during calibration. Referring to FIG. 3, in the embodiment, the relative relationship between the projection coordinates and the capturing coordinates may be obtained by the projection system 100B. Specifically, in the embodiment, the calibration may be performed before the projection device 120 projects an image. In an embodiment, the projection device 120 may be used to project a calibration beam LC on the projection target T1. In the embodiment, the calibration beam LC may form white dots at corners of the projection target T1. However, in other embodiments, the calibration pattern PC formed by the calibration beam LC on the projection target T1 may be other numbers, shapes or colors, and the disclosure is not limited thereto. Then, the image capturing device 110 performs image capturing on the calibration pattern PC formed on the projection target T1 by the calibration beam LC, so as to generate calibration information IC. In an embodiment, for example, the image capturing range SR defined by the image capturing device 110 on the projection target T1 is at least larger than the projection range PR defined by the projection device 120 on the projection target, such that the image capturing device 110 can perform image capturing directed to the projection target T1 located on the path of the projection beam L. In this embodiment, the data regarding the distance, the length, the width, the height and/or the coordinates of the boundary of the projection range PR relative to the projection device 120 can be calculated through the calibration information IC, and the disclosure is not limited thereto. In this way, the relative relationship or correlation between the projection coordinate of the projection range PR and the capturing coordinate of the image capturing range SR is calculated according to the calibration information IC. In this way, when a path target T2 (for example, a human face) enters into the transmitting path of the light beam projected by the projection device 120, the projection system 100B can determine the size, distance, and position of the path target T2, and further control the projection system 100B through the signal transmission between the image capturing device 110 and the projection device 120, thereby achieving intensity adjustment of at least a portion of the projection beam. For example, when the path target T2 exists on the projection path, the intensity of the light beam projected to the path target T2 is reduced. In some specific implementations, the intensity of the light beam projected to the path target T2 is decreased to zero.

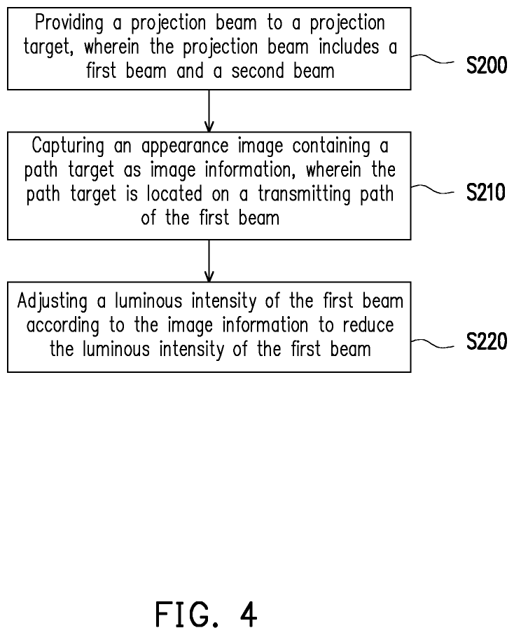

FIG. 4 is a flow chart of steps of a projection method according to an embodiment of the disclosure. Please refer to FIG. 1 and FIG. 4. The projection method of this embodiment may be performed by at least the projection system 100 illustrated in FIG. 1. The following description takes the projection system 100 as an example, but the disclosure is not limited thereto. In some embodiments, step S200 is performed to provide the projection beam L to the projection target T1, and the projection beam L includes the first beam L1 and the second beam L2. Step S210 is performed to capture the appearance image including the path target T2 as the image information IM, and the path target T2 is located on the transmitting path of the first beam L1. Step S220 is performed to adjust the luminous intensity of the first beam L1 according to the image information IM, so as to reduce the luminous intensity of the first beam L1. Therefore, by adjusting the luminous intensity of a portion of the light beam to be projected to the projection target T1, it is possible to prevent the light beam from being directly irradiated to a person, a human face, a human eye or other path targets so that the user is not irradiated or distracted by the projection beam L or even harmed when entering the projection region.

In summary, the embodiments of the disclosure have at least one of the following advantages or effects. In the projection system and the projection method of the embodiment, the image information is captured by the image capturing device, and the image information may be an appearance image including path targets such as a person, a human face, and a human eye. The projection system adjusts the laminating intensity of at least a portion of the projected light beam according to the image information, and reduces the luminous intensity of the light beam directed to the path target. In this configuration, by adjusting the luminous intensity of the light beam to be projected to the projection target, it is possible to prevent the light beam from being directly irradiated onto a person, a human face, a human eye or other path targets, so that the user is not irradiated or distracted by the projection beam or even harmed when entering the projection region.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A projection system, configured to project a projection beam toward a projection target, wherein the projection system comprises an image capturing device and a projection device, and wherein:
the image capturing device is configured to capture an appearance image comprising a path target as image information; and
the projection device is electrically connected to the image capturing device, the projection device provides the projection beam, and the projection beam comprises a first beam and a second beam, wherein the path target is located in a transmitting path of the first beam, and the second beam is projected onto the projection target, and the projection device adjusts an luminous intensity of the first beam according to the image information, so as to reduce the luminous intensity of the first beam.

2. The projection system of claim 1, wherein the image capturing device is built in the projection device.

3. The projection system of claim 1, wherein the image capturing device is located outside the projection device, and is electrically connected to the image capturing device by a wired connection or a wireless connection.

4. The projection system of claim 1, wherein the projection system further comprises:
a processing unit, electrically connected to the image capturing device and the projection device, wherein the processing unit is used to receive the image information and provide an adjustment control signal to the projection device, and the projection device is used to receive the adjustment control signal and adjust the luminous intensity of the first beam.

5. The projection system of claim 4, wherein the processing unit is built in the image capturing device or the projection device.

6. The projection system of claim 1, wherein the path target is a person, a human face or a human eye.

7. The projection system of claim 4, wherein the adjustment control signal comprises an image data and/or a coordinate data.

8. The projection system of claim 1, wherein the projection device comprises a light valve, and the projection device adjusts the light valve according to the image information.

9. The projection system of claim 1, wherein the luminous intensity of the first beam is adjusted to zero.

10. A projection method, comprising:
providing a projection beam to a projection target, wherein the projection beam comprises a first beam and a second beam;
capturing an appearance image comprising a path target as image information, wherein the path target is located on a transmitting path of the first beam; and
adjusting a luminous intensity of the first beam according to the image information, so as to reduce the luminous intensity of the first beam.

11. The projection method of claim 10, further comprising:
obtaining a relative relationship between a projection coordinate and a capturing coordinate.

12. The projection method of claim 11, wherein the step of obtaining the relative relationship between the projection coordinate and the capturing coordinate comprises:
providing a calibration beam to form a calibration pattern;
capturing the calibration pattern to generate calibration information; and
calculating the relative relationship between the projection coordinate and the capturing coordinate according to the calibration information.

13. The projection method of claim 10, wherein the step of adjusting the luminous intensity of the first beam according to the image information comprises:
generating an adjustment control signal according to the image information; and
providing the adjustment control signal, so as to reduce the luminous intensity of the first beam.

14. The projection method of claim 10, wherein the path target is a person, a human face or a human eye.

15. The projection method of claim 13, wherein the adjustment control signal comprises an image data and/or a coordinate data.

16. The projection method of claim 10, wherein the step of adjusting the luminous intensity of the first beam according to the image information further comprises:
adjusting the luminous intensity of the first beam to 0 according to the image information.
